(19) United States
(12) Patent Application Publication
(10) Pub. No.: US 2020/0339252 A1
(43) Pub. Date: Oct. 29, 2020

(54) ELECTRICALLY-POWERED SWIVELING TAIL ROTOR SYSTEMS

(71) Applicant: Bell Helicopter Textron Inc., Fort Worth, TX (US)

(72) Inventors: Jouyoung Jason Choi, Southlake, TX (US); Daniel Bryan Robertson, Southlake, TX (US)

(21) Appl. No.: 16/398,106

(22) Filed: Apr. 29, 2019

(51) Int. Cl. B64C 27/82

(52) U.S. Cl. CPC B64C 27/82; B64C 2027/8272; B64C 2027/8236; B64C 2027/8209

(57) ABSTRACT

According to one implementation of the present disclosure, a tail rotor system of a rotorcraft includes an electric motor, a swiveling actuator, a spindle, and a hub assembly. The hub assembly may be configured to position two or more blades. Also, in response to a control signal, the swiveling actuator may be configured to actuate swivel rotation of the spindle around a vertical axis such that the hub assembly turns from a first horizontal directional axis to a second horizontal directional axis.

### STATEMENT REGARDING FEDERALLY SPONSORED RESEARCH OR DEVELOPMENT

Not applicable.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Currently, compound helicopters (i.e., rotorcrafts) require separate systems for anti-torque and forward-flight propulsion. Moreover, tail rotors of such compound helicopters are powered by a main engine (i.e., powerplant) (e.g., a traditional piston engine or a light-weight turbine) through a drive shaft connection. However, such drive shafts are obtrusive in design and can limit the swiveling capabilities of a tail rotor; thus, preventing rotatory or fan blades of the tail rotor from rotation in a full range of directions.

### SUMMARY

According to one implementation of the present disclosure, a tail rotor system of a rotorcraft includes an electric motor, a swiveling actuator, a spindle, and a hub assembly. The hub assembly may be configured to position two or more blades. Also, in response to a control signal, the swiveling actuator may be configured to actuate swivel rotation of the spindle around a vertical axis such that the hub assembly turns from a first horizontal directional axis to a second horizontal directional axis.

According to one implementation of the present disclosure, a tail rotor system of a rotorcraft includes an electric motor, a swiveling actuator, a spindle, and a hub assembly. The hub assembly may be configured to position two or more blades. Also, in response to a control signal, the swiveling actuator may be configured to actuate swivel rotation of the spindle around a vertical spindle axis at the center of the tail rotor system.

According to another implementation of the present disclosure, a rotorcraft includes a rotorcraft assembly powered by a power source, and a tail rotor system powered by an electric motor. The tail rotor system of a rotorcraft includes an electric motor, a swiveling actuator, a spindle, and a hub assembly. The hub assembly may be configured to position two or more blades. Also, in response to a control signal, the swiveling actuator may be configured to actuate swiveling of the spindle around a first spindle axis such that the hub assembly turns from a first direction to a second direction.

The above-referenced summary section is provided to introduce a selection of concepts in a simplified form that are further described below in the detailed description section. Additional concepts and various other implementations are also described in the detailed description. The summary is not intended to identify key features or essential features of the claimed subject matter, nor is it intended to be used to limit the scope of the claimed subject matter, nor is it intended to limit the number of inventions described herein. Furthermore, the claimed subject matter is not limited to implementations that solve any or all disadvantages noted in any part of this disclosure.

### BRIEF DESCRIPTION OF THE DRAWINGS

The present technique(s) will be described further, by way of example, with reference to embodiments thereof as illustrated in the accompanying drawings. It should be understood, however, that the accompanying drawings illustrate only the various implementations described herein and are not meant to limit the scope of various techniques, methods, systems, or apparatuses described herein.

FIGS. 1A to 1C illustrate perspective views of a tail rotor system in accordance with implementations of various techniques described herein.

FIG. 2 illustrates a perspective view of a tail rotor system in accordance with implementations of various techniques described herein.

FIG. 3 illustrates a perspective view of a tail rotor system in accordance with implementations of various techniques described herein.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

Example embodiments of the present disclosure combine forward-flight propulsion and anti-torque systems into one system without any “swiveling” (i.e., to swing or turn as on a pivot) range constraints (due to a drive train system). Suitably, such embodiments provide for a tail rotor system that does not require a drive train system (including a drive shaft) to transfer power from the main power source (e.g., a powerplant) of a rotorcraft to a tail rotor.

Advantageously, inventive aspects of the present disclosure allow for a tail rotor spindle with the capacity to provide for a full range of tail rotor swivel rotation. As a further advantage, to further reduce parts and lower cost, an additional rotation gear box that had been necessary in driveshaft assembly may also be eliminated.

In addition, in contrast to conventions rotorcrafts that may employ collective control to change an amount of thrust (i.e., thrust level), in the present disclosure, the tail rotor system may be configured to change a thrust vector by rotor speed control (i.e., RPM control). Moreover, as rotation from a forward-flight mode to a hover mode occurs at the tail rotor system itself, no “offset” vertical swiveling may be required at locations proximate to the tailboom of a rotorcraft outside of the tail rotor system.

As referenced throughout the following description, directional axes': X-axis, Y-axis, Z-axis may be orthogonal to one another in a three-dimensional space.

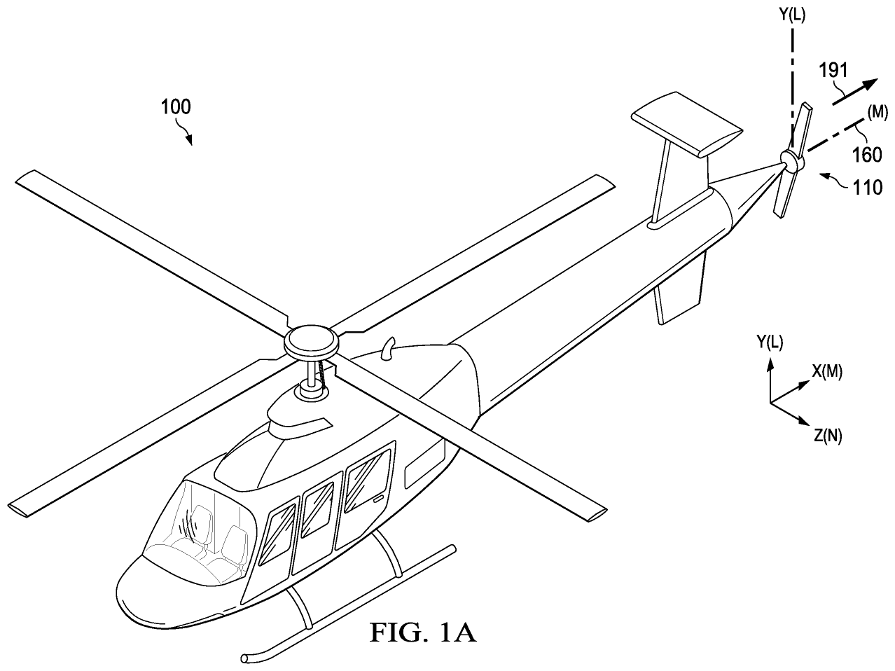

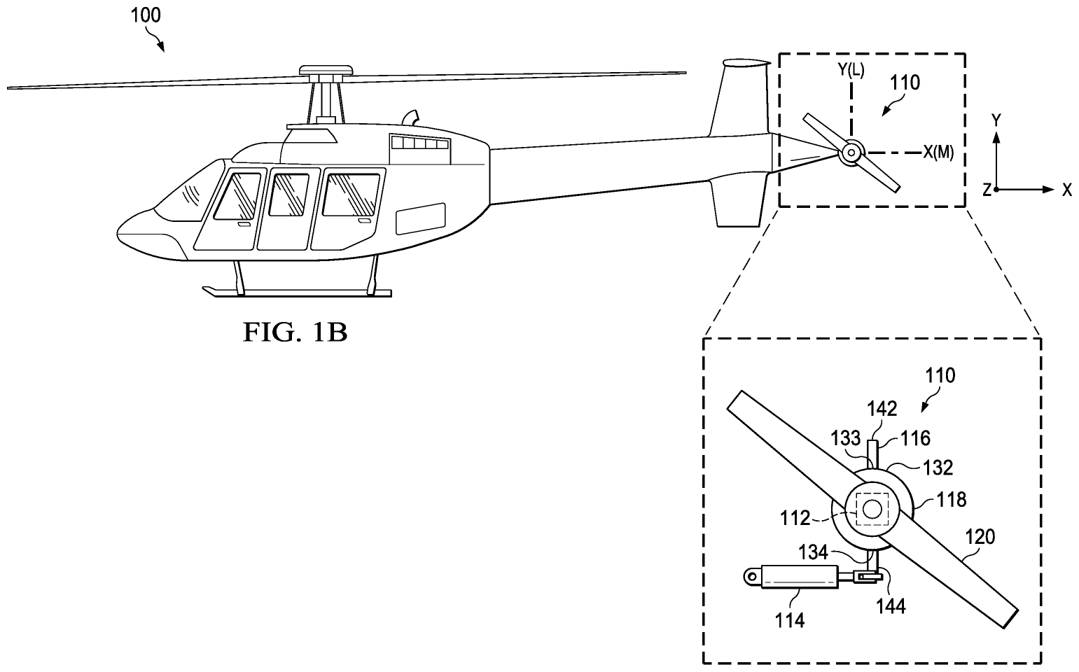

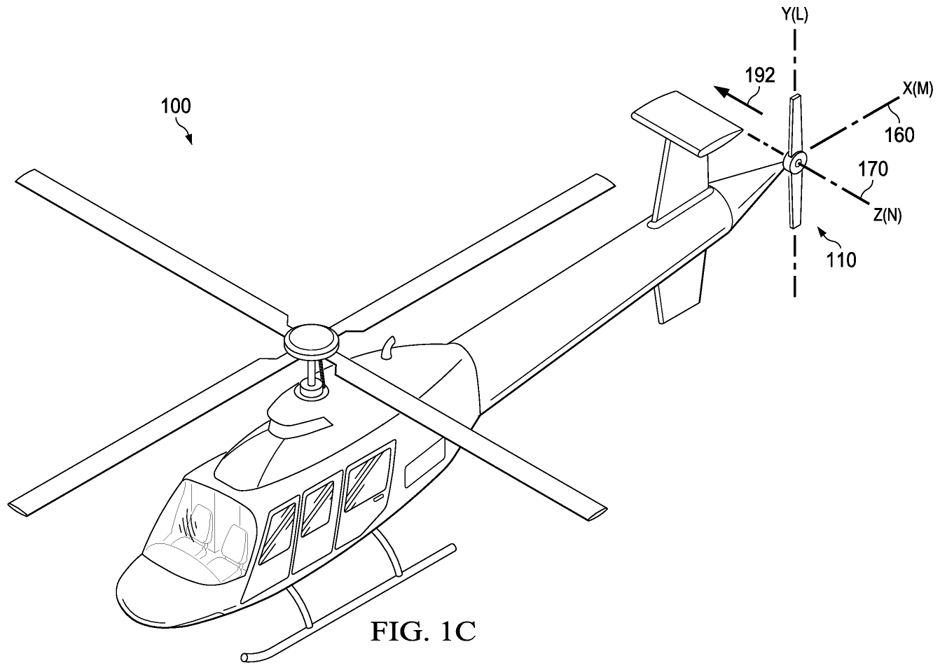

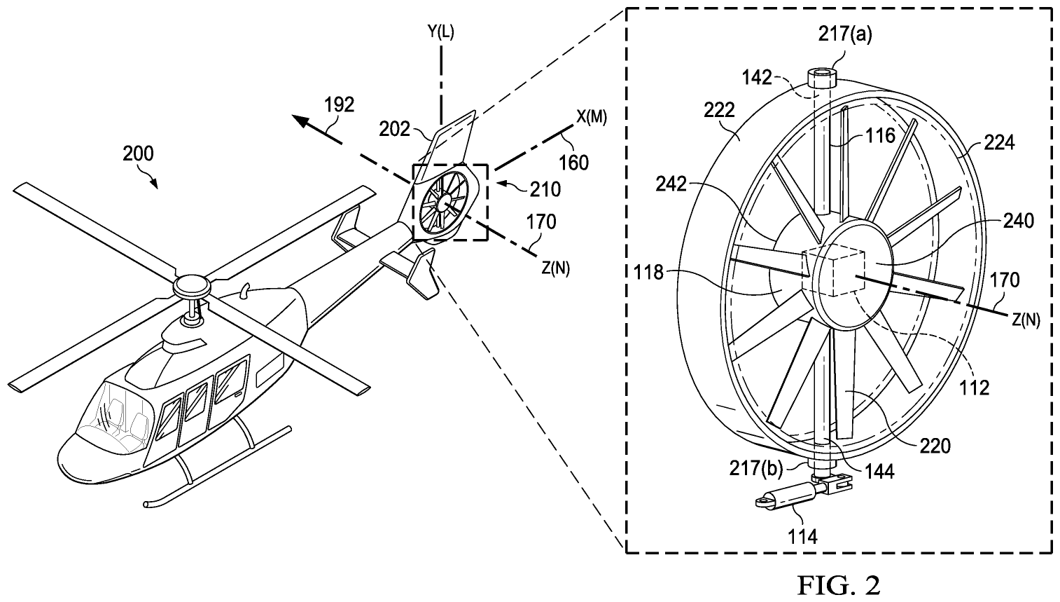

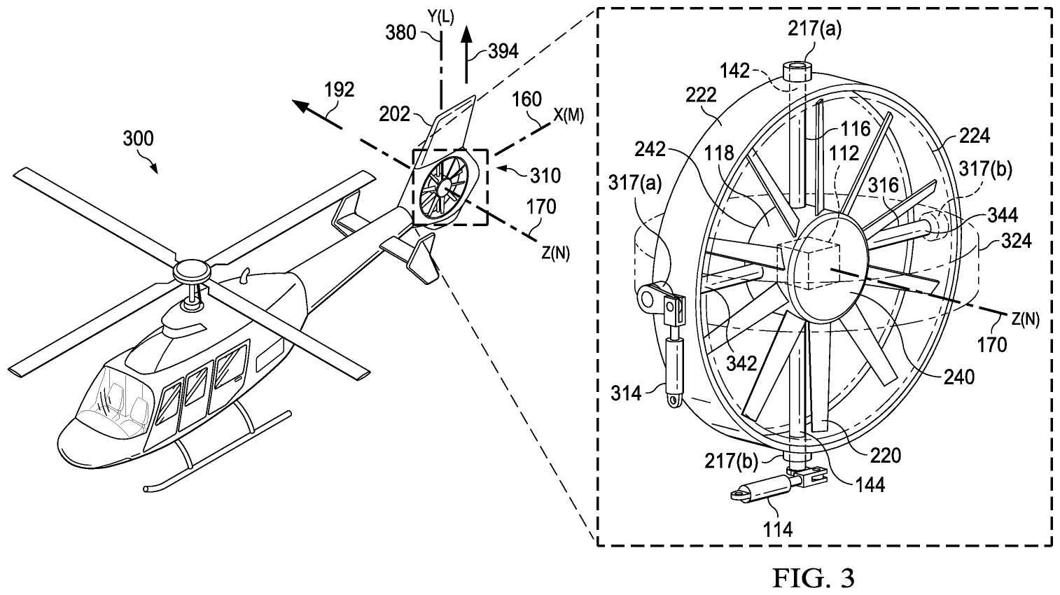

Referring to FIGS. 1A-C, perspective views of an open (i.e., un-ducted) electrically-powered tail rotor system 110 (i.e., tail rotor, tail rotor assembly, tail rotor system, propeller system) for a rotorcraft 100 is shown in a forward blight position (FIG. 1A) and hover position (FIGS. 1.13-C). As shown in FIGS. 1A-C, the tail rotor system 110 may include an electric motor 112, a swiveling actuator 114, a spindle 116, and a hub assembly 118. The hub assembly 118 may be configured to position the two or more blades 120 (i.e., blades, rotor blades, fan blades as shown in FIGS. 2-3). Moreover, in response to a control signal, the actuator 114 may be configured to actuate swivel rotation of the spindle 116 around a vertical axis (L) (i.e., a first spindle axis, a vertical Y-directional axis) such that the hub assembly 118 may pivot from a first directional axis 160 (i.e., a first horizontal directional axis, a first direction) (e.g., X-axis) to a second directional axis 170 (i.e., a second horizontal directional axis, a second direction) (e.g., Z-axis). In one implementation, as shown in FIG. 1A, starting from a forward-flight position (i.e., pusher-propeller position mode), the hub assembly 118 may turn on a pivot (i.e., swivel) a quarter-revolution (i.e., 90°) to a hover position (i.e., anti-torque position, stabilizing position) (as shown in FIGS. 1B-C).

In certain implementations, the spindle (i.e., first spindle) 116 may be of any narrow-elongated shape (e.g., cylindrical tube, rectangular tube) that extends from one end (i.e., a first end 142) of the tail rotor system 110 to another end (i.e., a second end 144) on the vertical Y-axis along a diameter of the tail rotor system 110. As shown in FIGS. 1A-B and 2, in one example, the first spindle 116 may be positioned to enter through the hub assembly 118 from one end 133 (i.e., a top end) of a circumferential curvature 132 of the hub assembly 118, and exit from a second end 134 (i.e., a bottom end) of the circumferential curvature 132. Hence, a pivoting rotation (i.e., rotating about a point, swiveling rotation) of the spindle 116 may, likewise, turn the hub assembly 118 in the same direction (e.g., along the vertical Y-directional-axis (L)). In one case, the spindle 116 may be positioned (to enter) centrally on the circumferential curvature 132. In another case, the spindle 116 may be positioned (to enter) “off-center” on the circumferential curvature 132. In both cases, however, the two or more blades 120 may be positioned in front of the spindle 116 on the circumferential curvature 132 of the hub assembly 118 (on a particular directional axis orientation). Also, in both cases, the spindle's 116 swivel rotation may allow for 0°-180° rotation of the hub assembly 118 (and the blades 120) (on the X-Y directional axes/X-Y plane).

In other examples (not shown), where the hub assembly 118 has a substantially, polyhedral shape, the first spindle 116 may be positioned to enter through a top side of the hub assembly 118 and exit from a bottom side of the hub assembly 118. Hence, a swivel rotation of the spindle 116 may likewise rotate the hub assembly in the same direction. In one example (not shown), where the hub assembly 118 has a substantially spherical shape, the first spindle 116 may be positioned to enter through a top end of the hub assembly 118 and exit from a bottom end of the hub assembly 118. In such examples as well, however, the two or more blades 120 may be positioned in front of the spindle 116 on the hub assembly 118 (on a particular directional axis orientation). Also, in both cases, the spindle's 116 swivel rotation may allow for 180° rotation of the hub assembly 118 (and the blades 120) (on the X-Y directional axes/X-Y plane).

Advantageously, the tail rotor system 110 has the capacity to provide thrust in a first thrust vector 191 on the first directional axis 160 (i.e., a first horizontal directional axis) (during forward-flight) (as shown in FIG. 1A), and in a second thrust vector 192 on the second directional axis 170 (i.e., a second horizontal directional axis) (while hovering) (as shown in FIG. 1C) (to compensate for torque generated by the main rotor of the rotorcraft 110). In another implementation, the hub assembly 118 may rotate 180°. In doing so, a particular thrust vector can be generated in the opposite direction to the first thrust vector 191. In other implementations, the hub assembly 118 may rotate to any directional axes between 0°-180° and allow for respective thrust vectors to be generated on the corresponding directional axes on the X-Y plane.

In certain implementations, the hub assembly 118 may be centrally located in the tail rotor system 110. In one case (as shown in FIG. 2), the hub assembly 118 may have a substantially cylindrical shape. In such a case, the hub assembly 118 may have first and second sides 240, 242 that each correspond to a diameter of the hub assembly 118. Also, as an example implementation, upon a quarter revolution rotation, the first side 240 may pivot from facing the first directional axis 160 to the second directional axis 170. In some other cases (not shown), the hub assembly 118 may have a substantially polyhedral shape. For instance, the hub assembly 118 may be substantially shaped as, but not limited to: a cuboid (e.g., rectangular prism, cube), triangular prism, pentagonal prism, hexagonal prisms, octahedron, etc. In such instances, a first side of the hub assembly 118 may correspond to a diameter of the hub assembly 118. Moreover, upon a quarter revolution rotation, a first side may pivot from facing the first directional axis 160 to the second directional axis 170. Additionally, for each of above cases, in other implementations, the pivoting of the first side may be in any degree of rotation, from 0°-180°, such that the first side may face respective directional axes on the X-Y plane.

In yet another case, the hub assembly 118 may have a substantially spherical shape. In such a case, the hub assembly 118 may have first and second curved sides that each correspond to a one-half circumference of the hub assembly 118. Also, as an example implementation, upon a quarter revolution rotation, the first curved side may pivot from facing the first directional axis 160 to the second directional axis 170. Additionally, for this case, in other implementations, the pivoting of the first curved side may be in any degree of rotation, from 0°-180°, such that the first curved side may face respective directional axes on the X-Y plane.

The two or more blades 120 may be positioned as elongated blades extending outward from the hub assembly 118. In one implementation, the two or more blades 120 may be configured to rotate around the hub assembly 118 based on a particular directional axis orientation of the hub assembly 118. In an example operation of the two or more blades 120, when the hub assembly 118 is positioned according to the first directional axis 160, the two or more blades may rotate around a first horizontal (M) axis of rotation on one or more Y-Z planes. In a second example operation of the two or more blades 120, when the hub assembly 118 is positioned according to the second directional axis 170, the two or more blades may rotate around a second horizontal (N) axis of rotation on one or more X-Z planes.

The tail rotor system 110 may further include the swiveling actuator 114. As mentioned, in response to one or more control signals (e.g., originating from a fly-by-wire system and coupled to the tail rotor system 100 via electrical wiring), the swiveling actuator 114 may be configured to actuate a pivot rotation (i.e., a swivel rotation) of the spindle 116. Also, the swiveling actuator 114 may be powered by the electric motor 112. In certain implementations, the swiveling actuator 114 may be positioned proximate to a particular end and/or in alignment with the spindle 116, the hub assembly 118, and/or the electric motor 112.

The tail rotor system 110 may further include the electric motor 112 as a tail rotor power source. In some implementations, the electric motor 112 may be any type of electric motor including, but not limited to, linear motors, rotational motors, conventional brushless motors, or thin-gap type motors, coaxial rotors, etc. In some examples, the electric motor may be aligned with or supported by (e.g., housed in) the hub assembly 118. In some other examples, the electric motor 112 may be positioned proximate to a particular end and/or in alignment with the spindle 116 and/or the actuator 114.

Advantageously, by having the electric motor 112 provide power to the tail rotor system 110, a drive shaft may not be required for operation of the tail rotor system 110. Hence, the tail rotor system 110 may be entirely disconnected from the rest of the electrical power components of the rotorcraft (including, a main rotor system and power plant). Advantageously, by providing for full disconnection, instead of collective control to change a thrust vector, the tail rotor system 110 may utilize (i.e., apply, employ) high rotation speed (revolutions per minute (RPM)) (i.e., rotor speed control, RPM control) of the turbine engine of the rotorcraft 100 into low speed for operation of the tail rotor system 110. Moreover, as a further advantage, in a certain case, the use of an electric motor may also allow for a combination of both collective and RPM control. Suitably, the collective control may be a slow rate collective. In such a case, in forward-flight, an inflow velocity may be greater than an inflow static pressure.

In one implementation, the tail rotor system 110 may also be coupled to a reduction gear set (not shown) in a tail gear box. As per safety standards, for manned rotorcrafts, a redundant system for rotation between a forward-flight position to a hover position and vice-versa may be required. Accordingly, a single reduction gear set in the tail rotor gear box may be coupled to the tail rotor system 110 such that the tail rotor system 110 may rotate from the first directional axis 160 to the second directional axis 170. Advantageously, because a powertrain is not required to drive the tail rotor system 110, in such an implementation with a sole gear set, no other gear box may be required for tail rotor operation. Correspondingly, an “offset” vertical rotation that may be distanced from the tail rotor is also not required.

In certain inventive aspects, the example rotorcrafts (100, 200, 300) as described herein include a rotorcraft assembly (including, but not limited to an airframe, fuselage, landing gear, powerplant, transmission, and main rotor system) that is powered by the powerplant (e.g., piston engine, turbine motor(s)) and a tail rotor system (110, 210, 310) powered by an electric motor. The tail rotor system may include the electric motor, a swiveling actuator, a spindle and a hub assembly. In certain implementations, the hub assembly may be configured to position two or more blades. Also, in response to a control signal, the swiveling actuator may be configured to actuate pivot rotation (i.e., swivel rotation, swiveling, rotating about a point) of the spindle around a first spindle axis (i.e., a vertical axis) such that the hub assembly may rotate from a first direction to a second direction. Moreover, the swiveling actuator may be configured to actuate swivel rotation of the spindle around a vertical spindle axis at the center of the tail rotor system.

Referring to FIG. 2, a perspective view of a ducted electrically-powered tail rotor system 210 (i.e., tail rotor, tail rotor assembly, tail rotor system, propeller system) for an example rotorcraft 200 is shown in the hover position. The tail rotor system 210 may be substantially similar in construction, materials, and operation to the tail rotor system 110 with the notable distinction that the tail rotor system 210 includes a duet 222. As shown in FIG. 2, the tail rotor system 210 may include the electric motor 112, the swiveling actuator 114, the spindle 116, the hub assembly 118, the two or more blades 220 (i.e., two or more fan blades), and the duct 222 (i.e., circular duct). Similar to as shown with reference to FIGS. 1A-C, in response to a control signal, the swiveling actuator 114 of the tail rotor system 210 may be configured to actuate swiveling of the spindle 116 around the vertical axis (L) (i.e., first spindle axis, a vertical Y-directional axis) such that the hub assembly 118 may pivot from the first directional axis 160 i.e., a first horizontal directional axis, a first direction) (e.g., X-axis) to the second directional axis 170 (i.e., a second horizontal directional axis, a second direction) (e.g., Z-axis). In one implementation, starting from a forward-flight position (i.e., pusher-propeller position mode), the hub assembly 118 may turn on a pivot (i.e., swivel) a quarter-revolution (i.e., 90°) to a hover position (i.e., anti-torque position, stabilizing position).

In certain implementations, as illustrated in FIG. 2, the duct 222 may be aligned to and affixed to a vertical fin 202 of the example rotorcraft 200, while circumferentially enclosing at least the swiveling actuator 114, the spindle 116, the hub assembly 118, and the two or more blades 120. As shown in FIG. 2, the tail rotor system 210 may further include a first sleeve 224 (i.e., ring). The first sleeve 224 may extend on an interior side of the duct 222, such that the duct 222 may circumferentially enclose the first sleeve 224. Upon a swiveling operation of the spindle 116, the first sleeve 224 may be configured to pivot along with the hub assembly 118 and the two or more blades 120. In some cases, when the first sleeve 224, the hub assembly 118, and the two or more blades 120 are pivoting, the duct 222 may remain unmoved (i.e., affixed) and aligned with the vertical fin 202. Advantageously, the inclusion of the duct 222 may allow for uniform pressure distribution within the tail rotor system 210 and improve noise and hover performance.

Also shown in FIG. 2, the tail rotor system 210 may further include first and second spindle bearings 217(a,b) (i.e., first and second rotational bearings). In certain implementations, the first and second spindle bearings 117(a,b) may secure the first and second ends 142, 144 of the spindle 116 to the duct 222, such that when actuated, the motion of the spindle 116 may be constrained to only a desired pivot rotation around the vertical axis (i.e., the first spindle axis).

Moreover, in addition to the description of the two or more blades 220 in above paragraphs, in one implementation of the tail rotor system 210, the two or more blades 220 may include twisted blades, which allow for better flight control performance.

Referring to FIG. 3, a perspective view of a ducted electrically-powered tail rotor system 310 (i.e., tail rotor, tail rotor assembly, tail rotor system, propeller system) for the example rotorcraft 300 is shown in the hover position. The tail rotor system 310 may be substantially similar in construction, materials, and operation to the tail rotor system 210 with the notable distinction that the tail rotor system 210 includes a second spindle 316 (and associated spindle bearings 317(a,b)) and a second swiveling actuator 314. As shown in FIG. 3, the tail rotor system 210 may include the electric motor 112, the first and second swiveling actuators 114, 214, first and second spindles 116, 316, the hub assembly 118 the two or more blades 220 (i.e., two or more fan blades), and the duct 222 (i.e., circular duct).

Expanding on what is shown with reference to FIGS. 1A-B, in response to first and second control signals, in an example operation, the swiveling actuators 114, 314 of the tail rotor system 310 may be configured to actuate swiveling of the first and second spindle 116, 316 around the vertical (L) (i.e., first spindle axis, vertical Z-directional axis) and a horizontal axis (i.e., second spindle axis) (e.g., a horizontal X-directional axis or a horizontal Z-directional axis), respectively, such that the hub assembly 118 may pivot from the first directional axis 160 (e.g., X-axis) to the second directional axis 170 (e.g., Z-axis), as well as from the first directional axis 160 or the second directional axis 170 to a third directional axis 380 (e.g., Y-axis). In one implementation, starting from a forward-flight position (i.e., pusher-propeller position mode), the hub assembly 118 may pivot a quarter-revolution (i.e., 90°) to a hover position (i.e., anti-torque position, stabilizing position), and subsequently pivot “downward” a quarter-revolution (i.e., 90°). Advantageously, as an example, to compensate for when a center of gravity may be offset (e.g., a yaw or pitch moment), such an implementation may provide vertical direction thrust 394 along the third directional axis 380. In other implementations, swiveling rotations from the first directional axis 160 or the second directional axis 170 to a third directional axis 380 can be of any degree of rotation of the second spindle 316 about the first horizontal axis (M), from 0°-180°, such that a thrust vector can be generated in any directional axis in an 180°-three-dimensional space. Advantageously, such rotational capacity may allow for concurrent pitch and yaw control; thus, allowing for precision in maneuverability.

As shown in FIG. 3, the second spindle 316 may be substantially similar to first spindle 116 in construction and operation. In contrast from the first spindle 116, the second spindle 316 may be positioned on a horizontal axis (e.g., such as the X-axis or the Z-axis). As shown in FIG. 3, the tail rotor system 310 may further include a second sleeve 324 (i.e., a second ring). Similar to the first sleeve 224, the second sleeve 324 may also extend on an interior side of the duct 222, such that the duct 222 may circumferentially enclose the second sleeve 324. Upon a pivot operation of the second spindle 316, the second sleeve 324 may be configured to pivot along with the hub assembly 118 and the two or more blades 120. In some cases, similar to as shown with reference to first sleeve 224, when the second sleeve 324, the hub assembly 118, and the two or more blades 120 are turning, the duct 222 may remain unmoved (i.e. affixed to) and aligned with the vertical fin 202.

As illustrated in FIG. 3, the tail rotor system 310 may further include the second swiveling actuator 314 for actuating swiveling of the second spindle 316. In some implementations, the second swiveling actuator 314 may be similar to as described with reference to the first swiveling actuator 114. Advantageously, the second swiveling actuator 314 along with the second sleeve 324 may allow for an implementation where the two or more blades 120 may be rotated relative to the first sleeve 124 (i.e., the first ring), as well as a second rotation of the second sleeve 324 relative to the rotorcraft 300. Accordingly, in this design implementation, if a control is desired for a little further “forward” or “aft”, a pilot (or a computer system in an unmanned rotorcraft operation) may utilize antitorque pedals to achieve a specified yaw rate and thrust for antitorque. Moreover, even in a forward-flight operation, a pilot (or a computer system in an unmanned rotorcraft operation) may have additional capacity to induce “a slight moment” on the rotorcraft for forward or backward tilt (i.e., pitch).

Also shown in FIG. 3, the tail rotor system 310 may further include the third and fourth spindle bearings 317(a,b) (i.e., third and fourth rotational bearings). In certain implementations, the third and fourth spindle bearings 317(a,b) may secure the first and second ends 342, 344 of the second spindle 316 to duct 222, such that when actuated, the motion of the second spindle 316 may be constrained to a desired swiveling around a horizontal axis.

In certain implementations, the two or more blades 220 may be positioned as elongated blades extending outward from the hub assembly 118. In one implementation with reference to the tail rotor system 310, the two or more blades 120 may be configured to rotate around the hub assembly 118 based on a particular directional axis orientation of the hub assembly 118. For example, when the hub assembly 118 is oriented to face a directional axis orientation to a particular XYZ coordinate in the 180°-three-dimensional space, the two or more blades 220 may rotate around a third axis of rotation in a direction oriented to the particular XYZ coordinate.

Also, as an additional advantage, in the case where two coaxial rotors are employed as the electric motor 112 for the tail rotor system 310, the gyroscopic moment effect that may occur during a particular swiveling rotation may be eliminated.

Moreover, in some implementations, for when the first or second spindles 116, 316 are actuated for swiveling rotation, the hub assembly 118 may include openings (i.e., notches, grooves) (not shown) allowing the hub assembly to turn through the respective second or first spindles 116, 316.

In the following description, numerous specific details are set forth to provide a thorough understanding of the disclosed concepts, which may be practiced without some or all of these particulars. In other instances, details of known devices and/or processes have been omitted to avoid unnecessarily obscuring the disclosure. While some concepts will be described in conjunction with specific examples, it will be understood that these examples are not intended to be limiting.

Unless otherwise indicated, the terms “first”, “second”, etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

Reference herein to “one example” means that one or more feature, structure, or characteristic described in connection with the example is included in at least one implementation. The phrase “one example” in various places in the specification may or may not be referring to the same example.

Illustrative, non-exhaustive examples, which may or may not be claimed, of the subject matter according to the present disclosure are provided below. Different examples of the device(s) disclosed herein include a variety of components, features, and functionalities. It should be understood that the various examples of the device(s) disclosed herein may include any of the components, features, and functionalities of any of the other examples of the device(s) disclosed herein in any combination, and all of such possibilities are intended to be within the scope of the present disclosure. Many modifications of examples set forth herein will come to mind to one skilled in the art to which the present disclosure pertains having the benefit of the teachings presented in the foregoing descriptions and the associated drawings.

Therefore, it is to be understood that the present disclosure is not to be limited to the specific examples illustrated and that modifications and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims. Accordingly, parenthetical reference numerals in the appended claims are presented for illustrative purposes only and are not intended to limit the scope of the claimed subject matter to the specific examples provided in the present disclosure.

What is claimed is:

1. A tail rotor system of a rotorcraft comprising:
an electric motor;
a swiveling actuator;
a spindle; and
a hub assembly configured to position two or more blades, and wherein in response to a control signal, the swiveling actuator is configured to actuate swivel rotation of the spindle around a vertical axis such that the hub assembly turns from a first horizontal directional axis to a second horizontal directional axis.

2. The tail rotor system of claim 1, wherein the tail rotor system is disconnected from a powerplant of the rotorcraft.

3. The tail rotor system of claim 1, wherein the tail rotor system is configured to change a thrust vector by rotor speed control.

4. The tail rotor system of claim 1, wherein the first horizontal directional axis corresponds to a forward-flight positioning, and wherein the second horizontal directional axis corresponds to a hover positioning.

5. The tail rotor system of claim 1, wherein the tail rotor system provides first and second thrust vectors on the respective first and second horizontal directional axis.

6. The tail rotor system of claim 1, wherein the hub-assembly has one of a substantially cylindrical or polyhedral shape.

7. The tail rotor system of claim 6, wherein a first side of the hub assembly corresponds to a diameter of the hub-assembly, and wherein, upon a one quarter-revolution rotation, the first side rotates from facing the first horizontal directional axis to facing the second horizontal directional axis.

8. The tail rotor system of claim 1, wherein the hub assembly has a substantially spherical shape.

9. The tail rotor system of claim 8, wherein a first curved-side of the hub assembly corresponds to a one-half circumference of the hub assembly, and wherein, upon a one quarter-revolution rotation, the first curved-side of the hub assembly rotates from facing the first horizontal direction axis to facing the second horizontal directional axis.

10. The system of claim 1, wherein the two or more blades are configured to rotate around the hub assembly based on a directional axis orientation of the hub assembly.

11. The tail rotor system of claim 1, wherein when the hub assembly is positioned corresponding to the first horizontal directional axis, the two or more blades rotate around the first horizontal axis of rotation.

12. The tail rotor system of claim 1, wherein when the hub assembly is positioned corresponding to the second horizontal directional axis, the two or more blades rotate around the second horizontal axis of rotation.

13. The tail rotor system of claim 1, further comprising
a reduction gear box configured to perform a rotation around a second vertical axis.

14. The tail rotor system of claim 1, further comprising:
a duct configured to circumferentially enclose the two or more blades, the hub assembly, and the spindle, and wherein the duct comprises a first sleeve.

15. The tail rotor system of claim 14, wherein, upon a rotation of the tail rotor system, the duct is affixed and aligned to a vertical fin.

16. The tail rotor system of claim 14, further comprising:
a second spindle;
a second sleeve; and
a second swiveling actuator, wherein in response to a second control signal, the second swiveling actuator is configured to actuate swivel rotation of the second spindle around a second spindle axis such that the hub assembly turns from either the first and second horizontal directions to a third direction.

17. The tail rotor system of claim 12, wherein when the hub assembly is positioned in the third direction, the two or more blades rotate around a third axis of rotation.

18. The tail rotor system of claim 16, wherein the tail rotor system is configured to provide thrust in a vertical direction and both yaw-control and pitch-control.

19. A tail rotor system of a rotorcraft comprising:
an electric motor;
a swiveling actuator;
a spindle; and
a hub assembly configured to position two or more blades, and wherein in response to a control signal, the swiveling actuator is configured to actuate swivel rotation of the spindle around a spindle axis at a center of the tail rotor system.

20. A rotorcraft comprising:
a rotorcraft assembly powered by a main power source; and
a tail rotor system powered by an electric motor, wherein the tail rotor comprises:
the electric motor;
a swiveling actuator;
a spindle; and
a hub assembly configured to position two or more blades and align the electric motor, and wherein in response to a control signal, the swiveling actuator is configured to actuate swiveling of the spindle around a vertical axis such that the hub assembly turns from a first direction to a second direction.
